(19) United States
(12) Patent Application Publication
(10) Pub. No.: US 2015/0087370 A1
(43) Pub. Date: Mar. 26, 2015

(54) VIDEO BACCARAT GAME WITH A VIRTUAL TABLE, OUTCOME HISTORY AND PLAYER SELECTION

(71) Applicant: Bally Gaming, Inc., Las Vegas, NV (US)

(72) Inventors: Yogendrasinh Hematji Rajput, Bangalore (IN); Mohan Kumar Areanalli Manju, Mysore (IN); Randy Hedrick, Reno, NV (US)

(21) Appl. No.: 14/465,729

(22) Filed: Aug. 21, 2014

Related U.S. Application Data
(60) Provisional application No. 61/881,062, filed on Sep. 23, 2013.

(51) Int. Cl. G07F 17/32

(52) U.S. Cl. CPC G07F 17/3293; G07F 17/3211
USPC 463/11

(57) ABSTRACT

A video gaming system is disclosed that includes one or more game processors, one or more video displays, an apparatus for a player to control the play of the game, and a memory device. The memory device stores software to control the game processor and is configured to: enable the player to select a virtual game to play from a plurality of virtual games on a virtual game floor; display play by the player of the selected game on the one or more video displays; display virtual gameplay of the non-selected games from the plurality of virtual games on a virtual game floor; display on the one or more video displays an outcome history of the play of the selected games; and enable the player to choose to begin playing a non-selected game instead of the selected game from the plurality of virtual games on a virtual game floor.

### CROSS-REFERENCE TO RELATED APPLICATIONS

This application claims priority to U.S. Provisional Patent Application No. 61/881,062 filed on Sep. 23, 2013, entitled Video Baccarat Game with a Virtual Table, Outcome History and Player Selection, all of which are incorporated by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE DISCLOSURE

This invention pertains generally to gaming machines and gaming terminals. More particularly, this invention relates to gaming machines and gaming terminals where one or more additional instances of a game are operated concurrently and virtually and where results are reported to the player so that the player may select to play one or more other instances which they may feel will produce better results.

### BACKGROUND

Baccarat is a very popular card game which is strictly a game of chance, with no skill or strategy involved. The game is about comparing cards dealt between two hands, the “player” and the “banker.” Each game has three possible outcomes: “player,” “banker,” and “tie.” Players may bet on any of these three places. The cards are dealt on table from an eight deck of cards (six, four or one deck in some variant) which is called “shoe.” Baccarat is typically played as a live table game where there is a live dealer and a physical table.

In live, table-based Baccarat players often maintain an outcome history of player wins, Banker wins and ties. Casinos may provide players with blank forms to record the history. As the dealer deals the cards to the Banker and Player hands the players record the outcomes trying to look for trends upon which to wager. It is a feature of Baccarat that the only decision the player must make is where to place their wager, i.e., Banker hand, Player hand and/or a Tie. The draw rules are strict in Baccarat and there is no input or decisions made by the player as to which of the Banker or Player hands will receive additional cards. These draw rules are well known.

In the past, Baccarat games are disclosed in which physical cards are dealt from a shoe which can read the cards. The cards as dealt are processed according to the well-known draw rules and, in an automated fashion, the outcome history is displayed.

In card room Baccarat where physical cards are used, a player may feel that their luck at a certain table is bad and then may move to another table. In those instances where the tables do not post a history of outcomes, the player would not know the history of any trends and would face the table without any information simply hoping their luck will be better.

It is known for players to play electronic Baccarat as well, whether at a casino venue or on-line. At a casino venue the player plays a single instance of a video, computer controlled, Baccarat game. At that particular gaming machine or terminal the player may simply either have to ride out a string of unfavourable, losing outcomes or choose to either move to another machine/terminal or quit.

### SUMMARY

Briefly, and in general terms, disclosed herein are systems and methods for providing a video gaming system. The system includes: one or more game processors; one or more video displays; a player input device configured to enable a player to control play of the game; and a memory device that stores software to control the game processor. The memory device further storing software that is configured to: enable the player to select a virtual game to play from a plurality of virtual games on a virtual game floor; display play by the player of the selected game on the one or more video displays; display virtual gameplay of the non-selected games from the plurality of virtual games on a virtual game floor; display on the one or more video displays an outcome history of the play of the selected games; and enable the player to choose to begin playing a non-selected game instead of the selected game from the plurality of virtual games on a virtual game floor.

In another embodiment, a method of playing a video gaming system is disclosed that includes one or more game processors, one or more video displays, a player input device configured to enable a player to control play of the game, and a memory device that stores software and controls the game processor. The method includes: enabling the player to select a virtual game to play from a plurality of virtual games on a virtual game floor; displaying play by the player of the selected game on the one or more video displays; displaying virtual gameplay of the non-selected games from the plurality of virtual games on a virtual game floor; displaying on the one or more video displays an outcome history of the play of the selected games; and enabling the player to choose to begin playing a non-selected game instead of the selected game from the plurality of virtual games on a virtual game floor.

The disclosed embodiments further relates to machine readable media on which are stored embodiments of the disclosed invention described in herein. It is contemplated that any media suitable for retrieving instructions is within the scope of the disclosed embodiments. By way of example, such media may take the form of magnetic, optical, or semiconductor media. The invention also relates to data structures that contain embodiments of the disclosed invention, and to the transmission of data structures containing embodiments of the disclosed invention.

Further advantages of the disclosed embodiments will be brought out in the following portions of the specification, wherein the detailed description is for the purpose of fully disclosing the various embodiments without placing limitations thereon.

While the invention is described with reference to Baccarat, it should be understood that it may apply as well to other games such as slot machine games where virtual instances of a game can be operated in the background without requiring any inter-game decisions by the player.

### BRIEF DESCRIPTION OF THE DRAWINGS

The present application will be more fully understood by reference to the following figures, which are for illustrative purposes only. The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

FIG. 1 illustrates a front view of a Baccarat video gaming system displaying a current virtual table 14 in its main presentation and showing a five game history of background virtual table 58 in its upper presentation.

FIG. 2 illustrates a front view of a Baccarat video gaming system displaying a current virtual table 14 in its main presentation and showing a one game history of background virtual table 81 in its upper presentation.

FIG. 3 illustrates a front view of a Baccarat video gaming system displaying a current virtual table 14 in its main presentation and showing a two game history of background virtual table 5 in its upper presentation.

FIG. 4 illustrates a front view of a Baccarat video gaming system displaying current virtual table 58 in its main presentation and showing background virtual table 81 in its upper presentation.

FIG. 5 illustrates a front view of a Baccarat video gaming system displaying current virtual table 81 in its main presentation and showing background virtual table 14 running with a random deal in its upper presentation.

FIG. 6 illustrates a front view of a Baccarat video gaming system displaying current virtual table 5 in its main presentation and showing background virtual table 81 in its upper presentation.

FIG. 7 illustrates a front view of a Baccarat video gaming system displaying current virtual table 72 in its main presentation and showing background virtual table 14 in its upper presentation.

FIG. 8 illustrates a front view of a Baccarat video gaming system displaying current virtual table 14 in its main presentation and showing five game history of background virtual table 58 in its upper presentation.

FIG. 9 illustrates a front view of a Baccarat video gaming system displaying a current virtual table 14 in its main presentation and showing a six game history of background virtual table 72 in its upper presentation.

FIG. 9a illustrates a front view of a Baccarat video gaming system displaying a current virtual table 8 with a player win in its main presentation and showing game histories of background virtual tables 108, 9, 88, and 81 in its upper presentation.

FIG. 9b illustrates a front view of a Baccarat video gaming system displaying a current virtual table 8 in its main presentation, showing game histories of background virtual tables 108, 9, 88, and 81 in its upper presentation, and showing a detailed history of background virtual table 108 in its lower presentation.

FIG. 10 illustrates a front view of a Baccarat video gaming system displaying a current virtual table 14 and its history.

FIG. 11 illustrates a perspective view of a gaming machine in accordance with one or more embodiments.

FIG. 12A illustrates a block diagram of the physical and logical components of the gaming machine of FIG. 1 in accordance with one or more embodiments.

FIG. 12B illustrates a block diagram of the physical and logical components of the gaming machine of FIG. 1 in accordance with one or more embodiments.

FIG. 13 illustrates a block diagram of the logical components of a gaming kernel in accordance with one or more embodiments.

FIG. 14A illustrates a schematic block diagram showing the hardware elements of a networked gaming system in accordance with one or more embodiments.

FIG. 14B illustrates a schematic block diagram showing the hardware elements of a networked gaming system in accordance with one or more embodiments.

FIG. 15 illustrates a diagram showing an example of architecture for tying a casino enterprise network to an external provider of games and content to Internet or broadband communication capable devices.

### DETAILED DESCRIPTION

Persons of ordinary skill in the art will understand that the present disclosure is illustrative only and not in any way limiting. Other embodiments of the presently disclosed system and method readily suggest themselves to such skilled persons having the benefit of this disclosure.

Each of the features and teachings disclosed herein can be utilized separately or in conjunction with other features and teachings to provide a system and method to provide user-configurable rules for team play on a single gaming machine. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present application also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

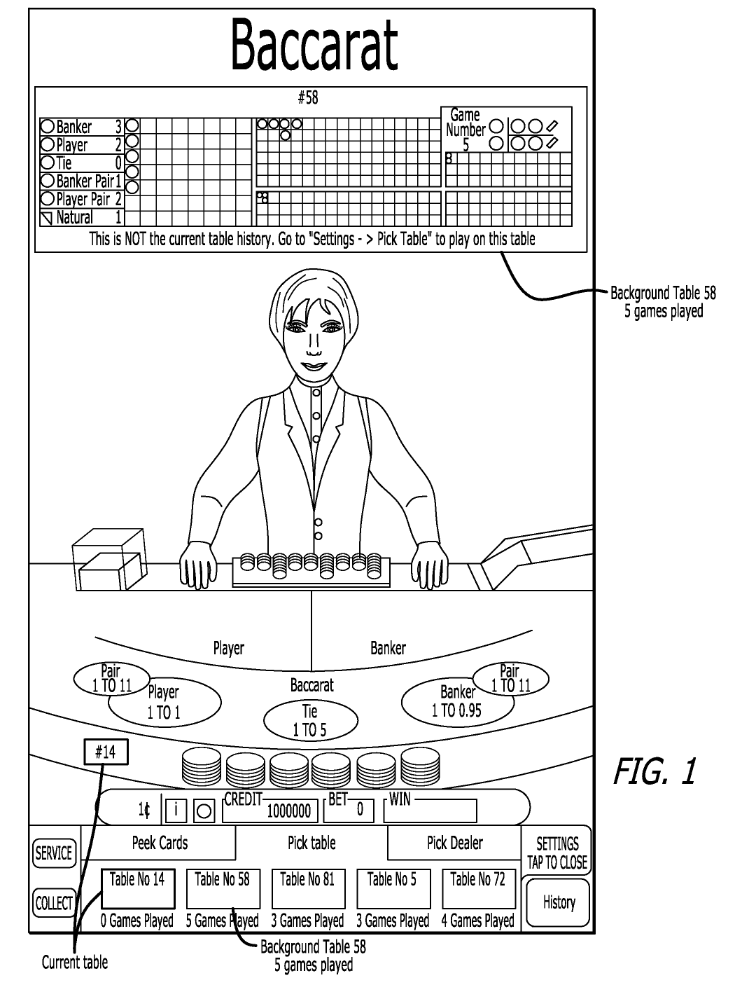

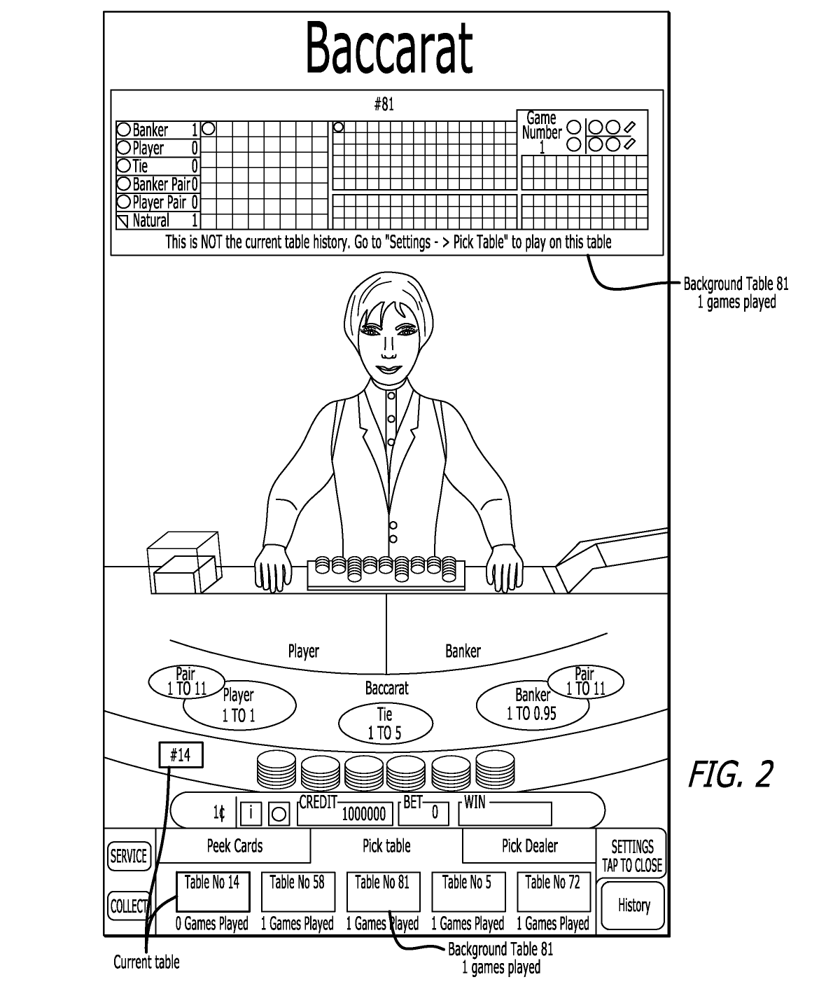

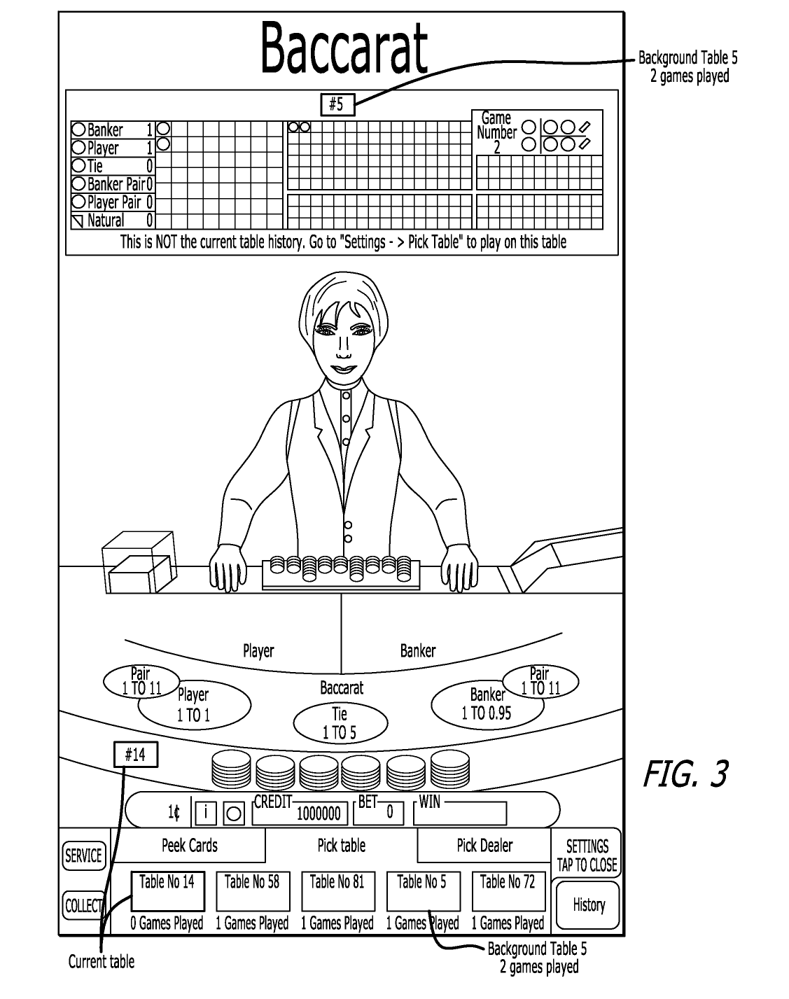

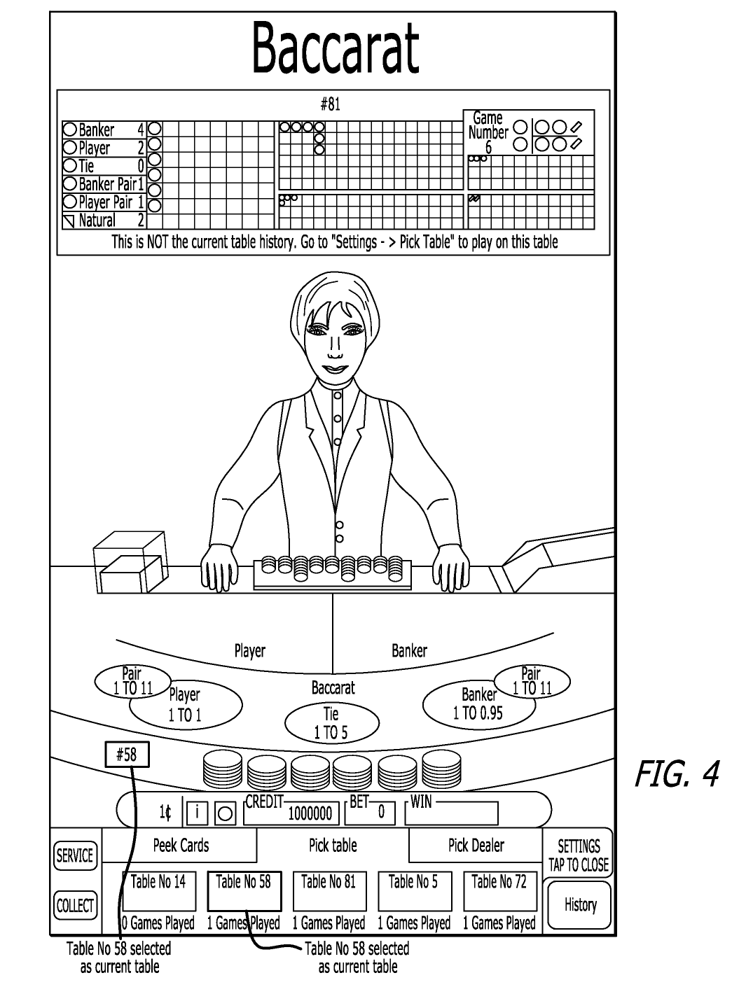

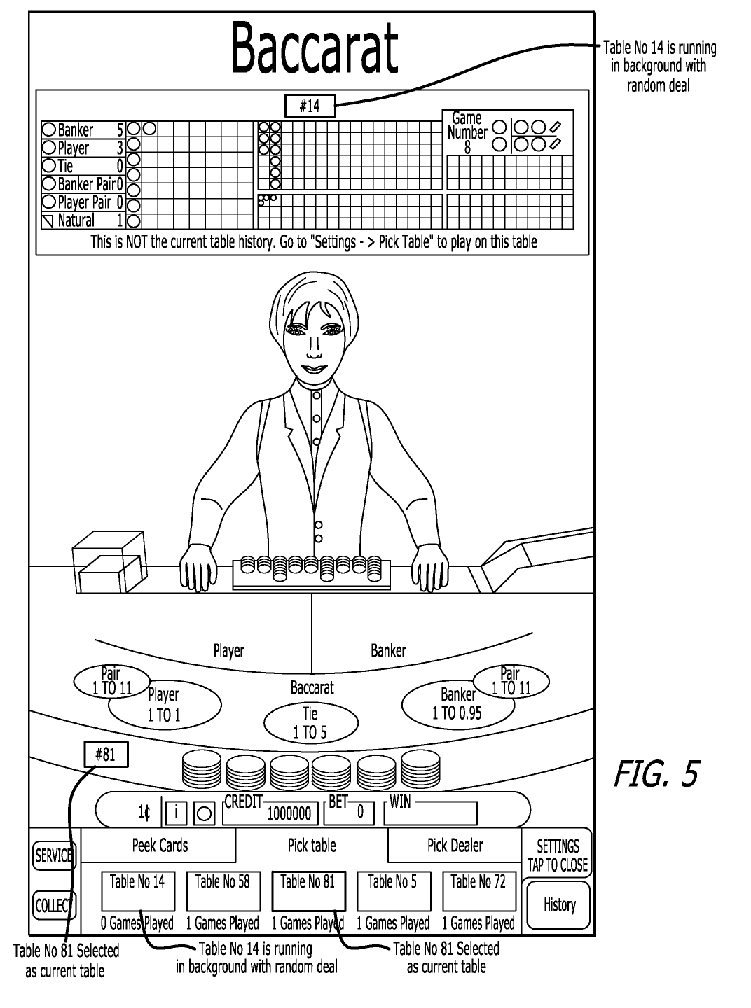

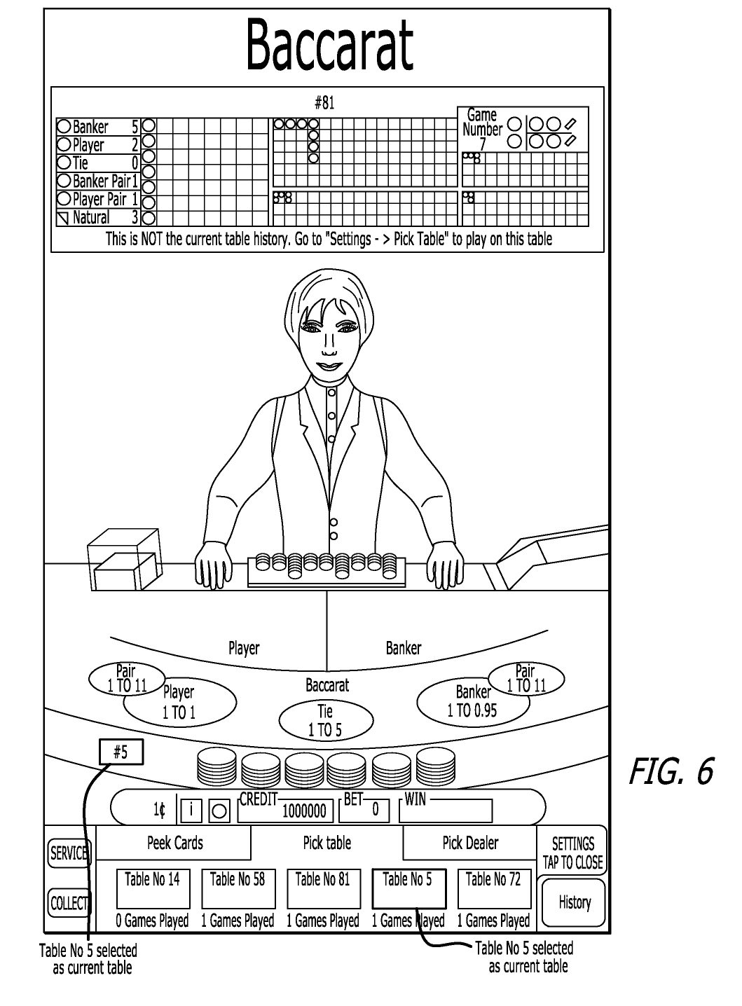

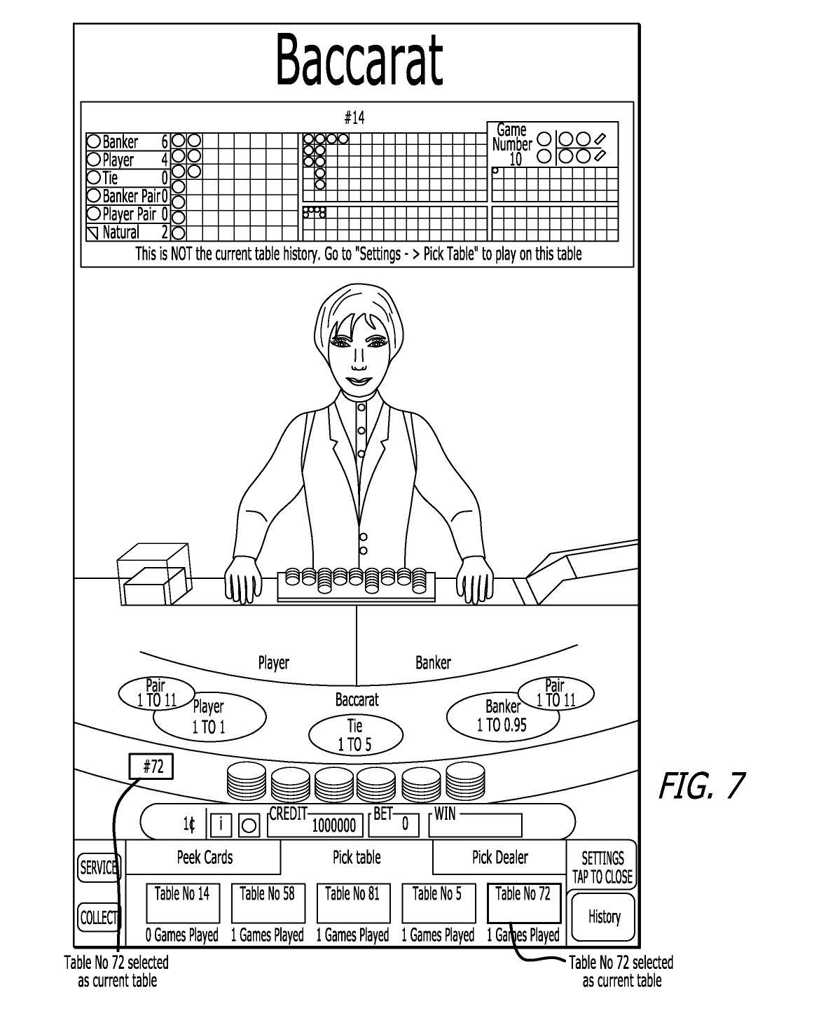

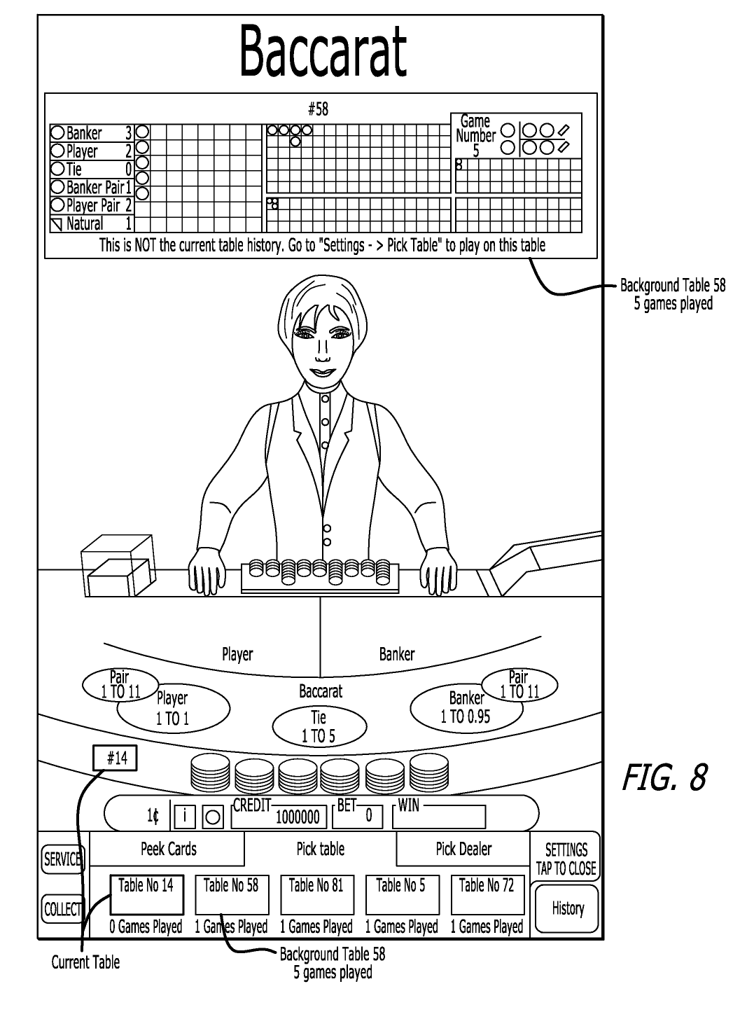

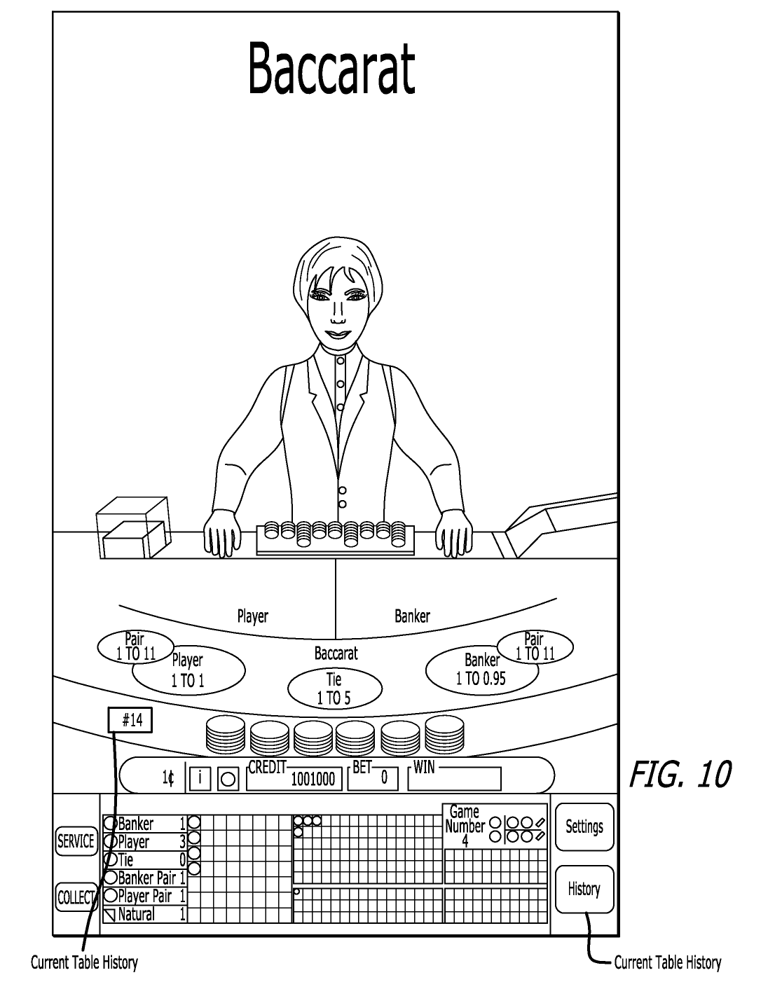

FIGS. 1-10 illustrate various embodiments of the disclosed “virtual game floor” system that are employed as a Baccarat video gaming system. Traditionally at a physical Baccarat table (or at Electronic Table Game (ETG) implementations of Baccarat), the Baccarat shoe history, which describes past hand outcomes, may be available. As players pass through the casino floor, they view the shoe history displayed at the physical tables and make a decision to play at a particular table where they like the pattern of past hand outcomes in the shoe history and feel that the odds of winning one or more future hands are in their favor.

In the present video Baccarat gaming system that employs the “virtual game floor” system, the system provides the ability for a player to choose from among multiple virtual tables on a “virtual game floor” displayed within a single gaming machine, with each virtual table having an associated card shoe and shoe history. Using this feature in the video Baccarat “virtual game floor” system, a player may: (1) choose a first virtual table to play from among a set of virtual tables; (2) view the shoe history pertaining to the selected table; (3) view shoe histories pertaining to the other non-selected tables, and (4) switch from the first virtual table to a second virtual table to play from among a set of virtual tables.

Notably, all of these actions may be made by a player from the same gaming machine. This “virtual game floor” functionality of the video Baccarat gaming system creates “virtual casino floor behavior” in which an avatar of the player walks around the virtual game floor as a virtual player, observes the shoe histories of the various virtual tables, and chooses one of the multiple virtual tables from which to participate in game play.

In one embodiment, each virtual table of the multiple virtual tables in the video Baccarat “virtual game floor” system on a single gaming machine comprises the following: (1) a virtual dealer character who deals out the cards; (2) a current virtual table at which the player is presently playing; (3) a virtual card shoe (card deck) associated with the current virtual table; (4) a hand history (outcome history) associated with the current virtual table; (5) one or more background virtual tables at which the player is not playing but random virtual cards deals are happening; and (6) a virtual card shoe and hand history (outcome history) associated with each background virtual table.

Notably, the player can move around on the “virtual game floor” and select between background virtual tables (using the information from the virtual card shoe and hand history associated with each background virtual table). In this regard, the player may also switch from a first virtual table to second virtual table, and so on, as the player desires (typically based on comparing the success at the player's current virtual table and the success at the other background virtual tables that the player can view while at its current virtual table.

As described above, a video Baccarat “virtual game floor” system running on a single game machine may have many multiple virtual tables running in the virtual background. Each background virtual table is like a real table in that each background virtual table is associated with its own card shoe and shoe history, all of which are viewable by the player. In addition to the card hands dealt on the current virtual table, the card hands dealt on the background virtual tables happen at regular or random intervals. Accordingly, in each hand of virtual play (like any other play on the current virtual table), cards are drawn from the associated shoe and those cards are not used again in the next deal. Background virtual play is continued just like current virtual play (or play with a physical card shoe) except no one is betting on these deals.

In some embodiments of the video Baccarat “virtual game floor” system, virtual deals occur on each virtual background table with selected random deal schedules. This virtual transaction of a game hand may occur in the various ways. In one embodiment, a virtual deal of cards may occur every T (number of) seconds on Table X. In this embodiment, the time “T,” once determined randomly, will be fixed. In another embodiment, the dealing of cards at every background virtual table may be absolutely random. This random progression of game play at background is typically the most realistic situation on a game floor where there is no correlation between the deal schedules on the tables.

Continuing, in some embodiments of the video Baccarat “virtual game floor” system, as the virtual deals occur on background virtual tables, cards are drawn from their respective shoes, and the shoe histories (outcomes) of each background table are updated. In one embodiment, the shoe histories of multiple background virtual tables are displayed on the electronic gaming machines, at least periodically (e.g., every 5 seconds) for a table.

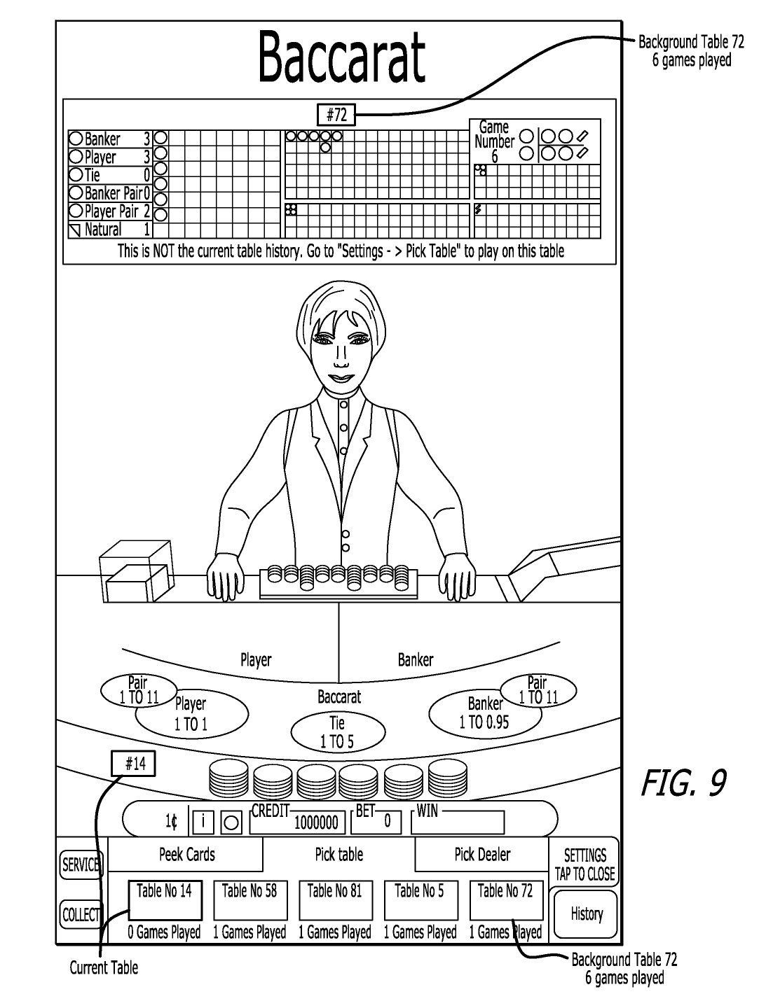

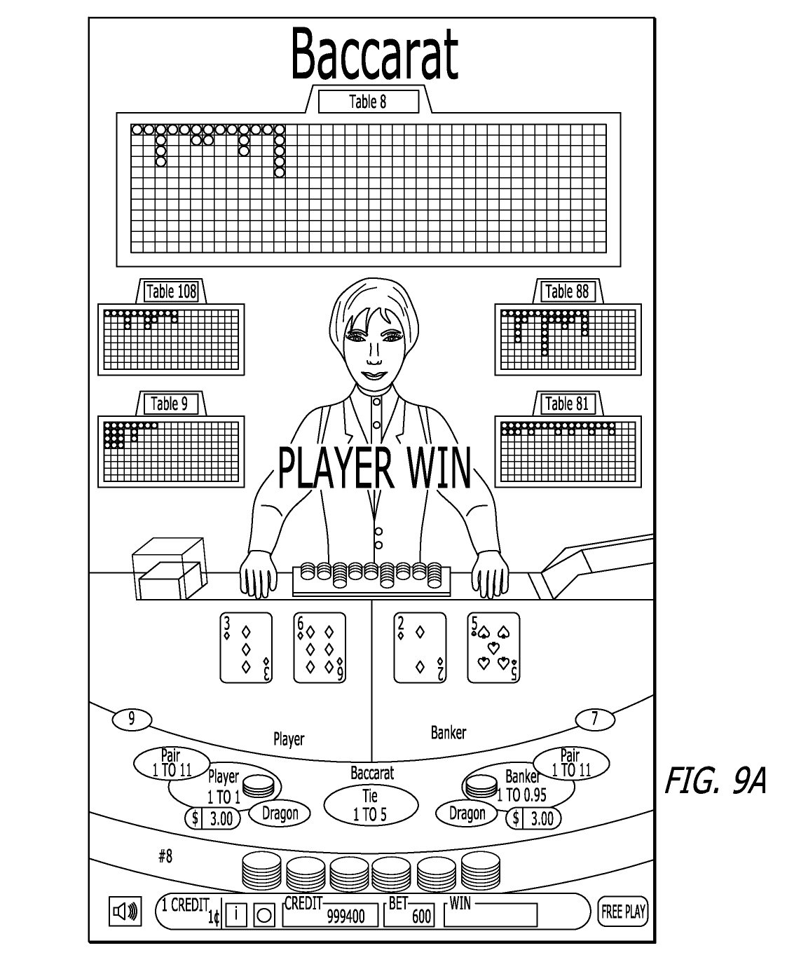

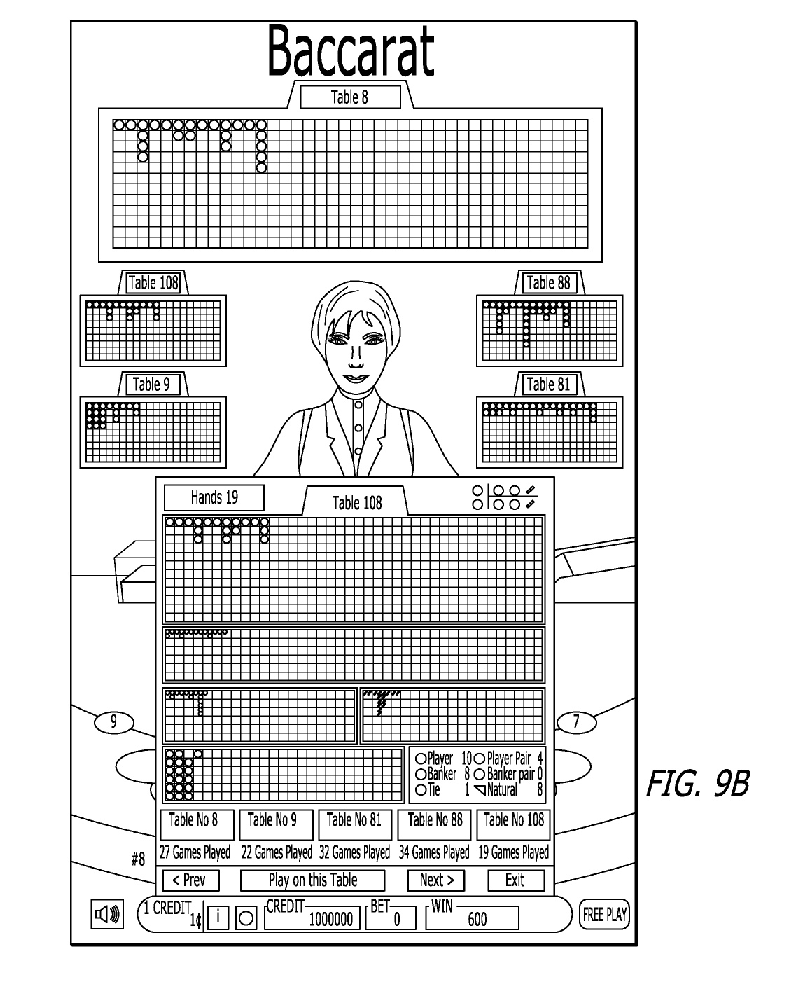

In other embodiments, as shown in FIGS. 9a and 9b, the shoe histories of multiple background virtual tables may be displayed concurrently on each of the electronic gaming machines, either automatically or by player selection. In this regard, FIG. 9a illustrates a front view of a Baccarat video gaming system displaying a current virtual table 8 with a player win in its main presentation and showing game histories of background virtual tables 108, 9, 88, and 81 in its upper presentation. In another such embodiment, FIG. 9b illustrates a front view of a Baccarat video gaming system displaying a current virtual table 8 in its main presentation, showing game histories of background virtual tables 108, 9, 88, and 81 in its upper presentation, and showing a detailed history of background virtual table 108 in its lower presentation.

In one embodiment of the video Baccarat “virtual game floor” system, the shoe histories of other background virtual tables may not represent the exact outcome of the virtual play (e.g., the histories of some background virtual tables may be made to look more attractive than their exact random outcome). This alteration of the background table histories is to keep the background table histories of other background virtual tables looking more attractive in certain situations (e.g., a virtual game machine is not occupied by a player, and thus, the associated background table history is used as an attract feature). However, in many embodiments of the video Baccarat “virtual game floor” system, the shoe histories of other background virtual tables do represent the exact outcome of the virtual play.

In some embodiments of the video Baccarat “virtual game floor” system, there are several background virtual tables that are supported by a single game machine. In one embodiment, shoe histories on the background tables are displayed on the top portion of the game screen one after the other. In such a display arrangement, the player may observe the results on the other background virtual tables while playing at the current virtual table. Preferably, each virtual table (including the current and the background virtual tables) has a table number. In several embodiments, the numbers are same across various electronic game machines that support the video Baccarat “virtual game floor” system. However, in some of these embodiments, two virtual tables with same numbers in two different electronic game machines are not the same virtual table.

As described above, in the video Baccarat “virtual game floor” system, a player can move on the virtual game floor from its current virtual table to any of the background virtual tables that are displayed, for example, on the top portion of the game screen. Once a player chooses a background virtual table to play, the selected background virtual table becomes the current virtual table, and the current table becomes one of the background virtual tables.

In one embodiment of the video Baccarat “virtual game floor” system, a player is playing on virtual table #58 (i.e., the player's current virtual table) and the player chooses to play one of the background virtual tables (e.g., virtual table #72). Then virtual table #58 becomes a background virtual table (i.e., eligible for virtual play) and background virtual table #72 becomes the current virtual table.

Notably, virtual game play stops when the background virtual table becomes the current virtual table. Correspondingly, shoe history from the prior virtual deals at the associated background virtual table is brought to the current virtual table. Similarly, when the current virtual table becomes one of the background virtual tables, the shoe history from the formerly current virtual table is carried over to the now background virtual table, and is continued for the virtual play.

In some embodiments, the video Baccarat “virtual game floor” system also enables a player to choose from a set of dealer characters. Players may choose a dealer based on their past experience and/or general belief systems pertaining to a particular geography or demography (e.g., tendencies and/or superstitions). In this manner, the player may select which virtual dealer character will be the virtual dealer for the table that the player selects. For example, the player may be superstitious and believe that they play better with a dealer that has particular characteristics, including by way of example only and not by way of limitation: a particular gender, a particular age, a particular hair color, a particular hair length, a particular build/weight, a particular nationality/ethnicity, a particular level of attractiveness, a particular level of friendliness (e.g., “southern charm,” “New York briskness,” or the like).

The “virtual game floor” system may be incorporated into various types of gaming tables in addition to Baccarat, such as other table game like Blackjack, Roulette. In one embodiment, a Roulette game on an electronic gaming machine may have multiple virtual background tables each playing a Roulette game on the background virtual game floor in addition to the Roulette game on the current virtual table.

In some embodiments of the “virtual game floor” system (including Baccarat, Blackjack, Roulette, and the like), the player may play on multiple virtual tables at the same time. In such an embodiment, whichever tables the player is playing become current tables. In some such embodiments, the graphical user interface of the supporting physical gaming machine must include a sufficient display(s) and processing power to support the presentation of concurrent deals (game play) on multiple virtual tables at the same time. In one embodiment, the virtual tables are unique between electronic (physical) gaming machines of the same game type.

In some embodiments, the video Baccarat “virtual game floor” system, Baccarat electronic (physical) gaming machines are linked together over a LAN environment with a common set of virtual tables shown on the virtual game floor, each virtual table having its own unique table ID. A player can choose one of the virtual tables on the virtual game floor from the set of virtual tables on the virtual game floor. The remaining virtual tables become the background virtual tables for that particular player.

Accordingly, in one embodiment of the video Baccarat “virtual game floor” system, a Player A on Baccarat EGM #1 and Player B on Baccarat EGM #2 are playing on virtual table #55. In this scenario, the card dealing on virtual table #55 in both the EGMs is synchronized. The other virtual tables appear as background virtual tables in EGM #1 and EGM #2. Additionally, there may be a greater number of virtual tables than there are EGMs. For instance, there can be ten background virtual tables and only five EGMs. Any virtual table that is not a current virtual table in any of the EGMs, become a background virtual table in all machines.

In another aspect of the video Baccarat “virtual game floor” system, unoccupied virtual tables (i.e., tables not chosen by any player) become background virtual tables in all of the EGMs. In this regard, each of the background virtual tables has a virtual card deal and associated shoe history. Virtual deals occur only for unoccupied tables. Occupied tables, shown as background virtual tables, display the number of people who have selected the table as the current table.

In such an embodiment, the shoe history is the actual card deal history and there are no virtual deals on the occupied tables. A virtual table can display data such as the number of people playing and the total bets placed on current tables, apart from the shoe history. Additionally, the virtual tables may have more derived properties from shoe history (i.e., past outcomes). These derived properties may include, for example, “hotness of the table” based on repeated win of a particular hand.

The “virtual game floor” system may be effective in attracting a player to Baccarat or another virtual card game on an electronic gaming machine. In the “virtual game floor” system, a player can try his luck on other background virtual tables. Each virtual table may have an associated color, look, and feel. Players may have preferences towards these associated colors, looks, and feels. In linked games scenarios, players can look at other virtual tables, determine the performance based on the history, and join the desired virtual table.

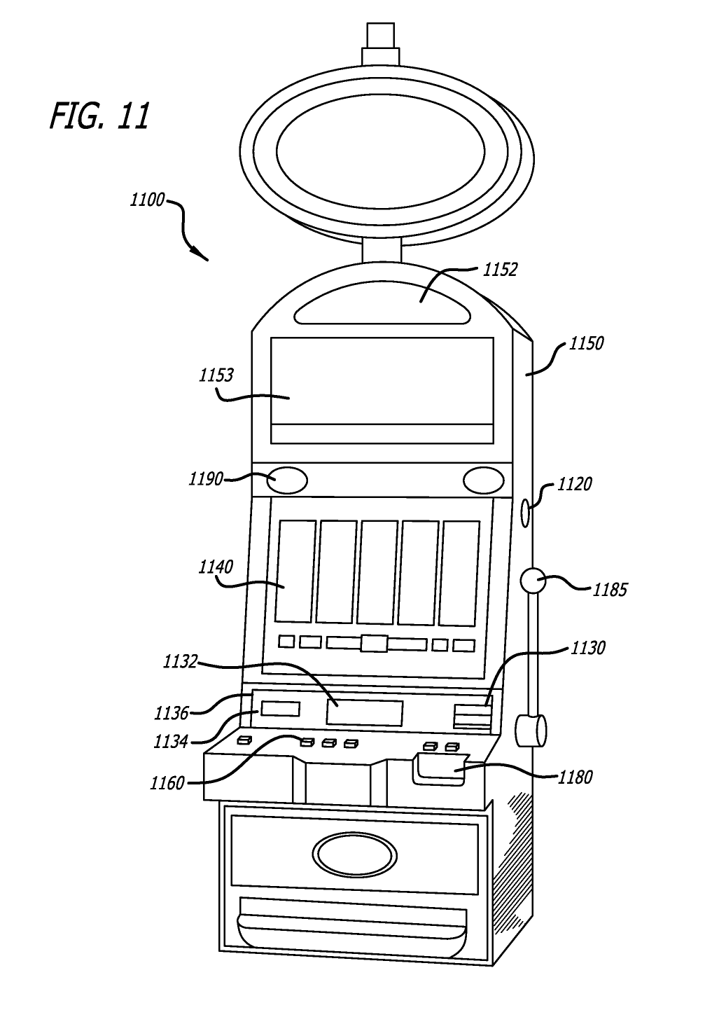

Referring to FIG. 11, gaming machine 1100 capable of supporting various embodiments of the invention described in Appendix A is shown, including cabinet housing 1120, primary game display 1140 upon which a primary game and feature game may be displayed, top box 1150 which may display multiple progressives that may be won during play of the feature game, player-activated buttons 1160, player tracking panel 1136, bill/voucher acceptor 1180 and one or more speakers 1190. Cabinet housing 1120 may be a self-standing unit that is generally rectangular in shape and may be manufactured with reinforced steel or other rigid materials which are resistant to tampering and vandalism. Cabinet housing 1120 may alternatively be a handheld device including the gaming functionality as discussed herein and including various of the described components herein. For example, a handheld device may be a cell phone, personal data assistant, or laptop or tablet computer, each of which may include a display, a processor, and memory sufficient to support either stand-alone capability such as gaming machine 1100 or thin client capability such as that incorporating some of the capability of a remote server.

In one or more embodiments, cabinet housing 1120 houses a processor, circuitry, and software (not shown) for receiving signals from the player-activated buttons 1160, operating the games, and transmitting signals to the respective displays and speakers. Any shaped cabinet may be implemented with any embodiment of gaming machine 1100 so long as it provides access to a player for playing a game. For example, cabinet 1120 may comprise a slant-top, bar-top, or table-top style cabinet, including a Bally Cinevision™ or CineReels™ cabinet. The operation of gaming machine 1100 is described more fully below.

The plurality of player-activated buttons 1160 may be used for various functions such as, but not limited to, selecting a wager denomination, selecting a game to be played, selecting a wager amount per game, initiating a game, or cashing out money from gaming machine 1100. Buttons 1160 may be operable as input mechanisms and may include mechanical buttons, electromechanical buttons or touch screen buttons. Optionally, a handle 1185 may be rotated by a player to initiate a game.

In one or more embodiments, buttons 1160 may be replaced with various other input mechanisms known in the art such as, but not limited to, a touch screen system, touch pad, track ball, mouse, switches, toggle switches, or other input means used to accept player input such as a Bally iDeck™. One other example input means is a universal button module as disclosed in U.S. Patent Publication No. 20060247047, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Cabinet housing 1120 may optionally include top box 1150 which contains “top glass” 1152 comprising advertising or payout information related to the game or games available on gaming machine 1100. Player tracking panel 1136 includes player tracking card reader 1134 and player tracking display 1132. Voucher printer 1130 may be integrated into player tracking panel 1136 or installed elsewhere in cabinet housing 1120 or top box 1150.

Game display 1140 may present a game of chance wherein a player receives one or more outcomes from a set of potential outcomes. For example, one such game of chance is a video slot machine game. In other aspects of the invention, gaming machine 1100 may present a video or mechanical reel slot machine, a video keno game, a lottery game, a bingo game, a Class II bingo game, a roulette game, a craps game, a blackjack game, a mechanical or video representation of a wheel game or the like.

Mechanical or video/mechanical embodiments may include game displays such as mechanical reels, wheels, or dice as required to present the game to the player. In video/mechanical or pure video embodiments, game display 1140 is, typically, a CRT or a flat-panel display in the form of, but not limited to, liquid crystal, plasma, electroluminescent, vacuum fluorescent, field emission, or any other type of panel display known or developed in the art. Game display 1140 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 440 preferably includes a touch screen or touch glass system (not shown) and presents player interfaces such as, but not limited to, credit meter (not shown), win meter (not shown) and touch screen buttons (not shown). An example of a touch glass system is disclosed in U.S. Pat. No. 6,942,571, entitled “Gaming Device with Direction and Speed Control of Mechanical Reels Using Touch Screen,” which is hereby incorporated by reference in its entirety for all purposes.

Game display 1140 may also present information such as, but not limited to, player information, advertisements and casino promotions, graphic displays, news and sports updates, or even offer an alternate game. This information may be generated through a host computer networked with gaming machine 1100 on its own initiative or it may be obtained by request of the player using either one or more of the plurality of player-activated buttons 1160; the game display itself, if game display 1140 comprises a touch screen or similar technology; buttons (not shown) mounted about game display 1140 which may permit selections such as those found on an ATM machine, where legends on the screen are associated with respective selecting buttons; or any player input device that offers the required functionality.

Cabinet housing 1120 incorporates a single game display 1140. However, in alternate embodiments, cabinet housing 1120 or top box 1150 may house one or more additional displays 1153 or components used for various purposes including additional game play screens, animated “top glass,” progressive meters or mechanical or electromechanical devices (not shown) such as, but not limited to, wheels, pointers or reels. The additional displays may or may not include a touch screen or touch glass system.

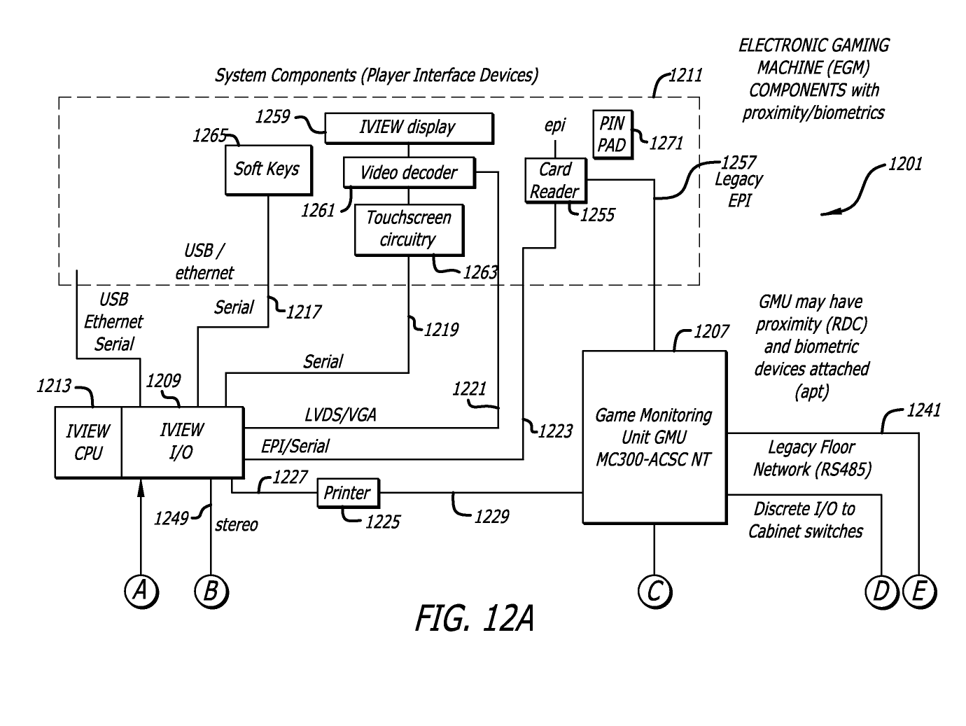

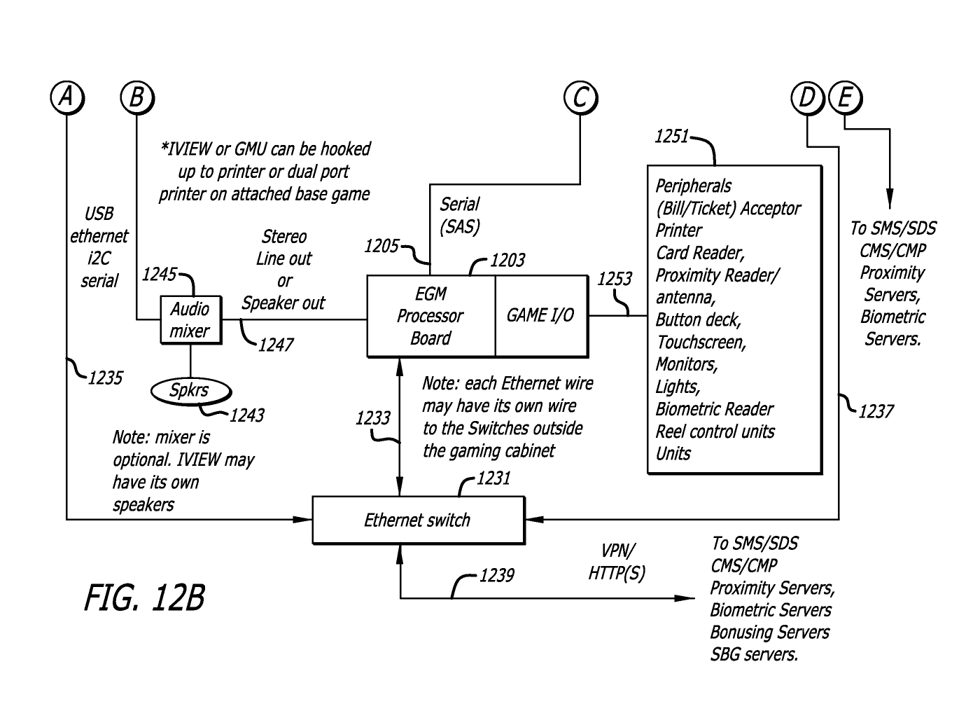

Referring to FIGS. 12A and 12B, electronic gaming machine 1201 is shown in accordance with one or more embodiments. Electronic gaming machine 1201 includes base game integrated circuit board 1203 (EGM Processor Board) connected through serial bus line 1205 to game monitoring unit (GMU) 1207 (such as a Bally MC300 or ACSC NT), and player interface integrated circuit board (PIB) 1209 connected to player interface devices 1211 over bus lines 1213, 1215, 1217, 1219, 1221, 1223. Printer 1225 is connected to PIB 1209 and GMU 1207 over bus lines 1227, 1229. Base game integrated circuit board 1203, PIB 1209, and GMU 1207 connect to Ethernet switch 1231 over bus lines 1233, 1235, 1237. Ethernet switch 1231 connects to a slot management system (SMS) and a casino management system (CMS) network over bus line 1239. GMU 1207 also may connect to the SMS and CMS network over bus line 1241. Speakers 1243 connect through audio mixer 1245 and bus lines 1247, 1249 to base game integrated circuit board 1203 and PIB 1209. The proximity and biometric devices and circuitry may be installed by upgrading a commercially available PIB 1209, such as a Bally iView™ unit. Coding executed on base game integrated circuit board 1203, PIB 1209, and/or GMU 1207 may be upgraded to integrate a game in accordance with one or more embodiments of the invention described herein, as is more fully described below.

Peripherals 1251 connect through I/O board 1253 to base game integrated circuit board 1203. For example, a bill/ticket acceptor is typically connected to a game input-output board 1253 which is, in turn, connected to a conventional central processing unit (“CPU”) base game integrated circuit board 1203, such as an Intel Pentium microprocessor mounted on a gaming motherboard. I/O board 1253 may be connected to base game integrated circuit board 1203 by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. Base game integrated circuit board 1203 executes a game program that causes base game integrated circuit board 1203 to play a game. In one embodiment, the game program provides a slot machine game having adjustable multi-part indicia. The various components and included devices may be installed with conventionally and/or commercially available components, devices, and circuitry into a conventional and/or commercially available gaming machine cabinet, examples of which are described above.

When a player has inserted a form of currency such as, for example and without limitation, paper currency, coins or tokens, cashless tickets or vouchers, electronic funds transfers or the like into the currency acceptor, a signal is sent by way of I/O board 1253 to base game integrated circuit board 1203 which, in turn, assigns an appropriate number of credits for play in accordance with the game program. The player may further control the operation of the gaming machine by way of other peripherals 1251, for example, to select the amount to wager via electromechanical or touch screen buttons. The game starts in response to the player operating a start mechanism such as a handle or touch screen icon. The game program includes a random number generator to provide a display of randomly selected indicia on one or more displays. In some embodiments, the random generator may be physically separate from gaming machine 1200; for example, it may be part of a central determination host system which provides random game outcomes to the game program. Thereafter, the player may or may not interact with the game through electromechanical or touch screen buttons to change the displayed indicia. Finally, base game integrated circuit board 1203 under control of the game program and OS compares the final display of indicia to a pay table. The set of possible game outcomes may include a subset of outcomes related to the triggering of a feature game. In the event the displayed outcome is a member of this subset, base game integrated circuit board 1203, under control of the game program and by way of I/O Board 1253, may cause feature game play to be presented on a feature display.

Predetermined payout amounts for certain outcomes, including feature game outcomes, are stored as part of the game program. Such payout amounts are, in response to instructions from base game integrated circuit board 1203, provided to the player in the form of coins, credits or currency via I/O board 1253 and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with the EGM are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the EGM using USB, serial or Ethernet connections. Each of the respective devices may have upgrades to their firmware utilizing these connections.

GMU 1207 includes an integrated circuit board and GMU processor and memory including coding for network communications, such as the G2S (game-to-system) protocol from the Gaming Standards Association, Las Vegas, Nev., used for system communications over the network. As shown, GMU 1207 may connect to card reader 1255 through bus 1257 and may thereby obtain player card information and transmit the information over the network through bus 1241. Gaming activity information may be transferred by the base game integrated circuit board 1203 to GMU 1207 where the information may be translated into a network protocol, such as S2S, for transmission to a server, such as a player tracking server, where information about a player's playing activity may be stored in a designated server database.

PIB 1209 includes an integrated circuit board, PID processor, and memory which includes an operating system, such as Windows CE, a player interface program which may be executable by the PID processor together with various input/output (I/O) drivers for respective devices which connect to PIB 1209, such as player interface devices 1211, and which may further include various games or game components playable on PIB 1209 or playable on a connected network server and PIB 1209 is operable as the player interface. PIB 1209 connects to card reader 1255 through bus 1223, display 1259 through video decoder 1261 and bus 1221, such as an LVDS or VGA bus.

As part of its programming, the PID processor executes coding to drive display 1259 and provide messages and information to a player. Touch screen circuitry interactively connects display 1259 and video decoder 1261 to PIB 1209, such that a player may input information and cause the information to be transmitted to PIB 1209 either on the player's initiative or responsive to a query by PIB 1209. Additionally soft keys 1265 connect through bus 1217 to PIB 1209 and operate together with display 1259 to provide information or queries to a player and receive responses or queries from the player. PIB 1209, in turn, communicates over the CMS/SMS network through Ethernet switch 1231 and busses 1235, 1239 and with respective servers, such as a player tracking server.

Player interface devices 1211 are linked into the virtual private network of the system components in gaming machine 1201. The system components include the iView processing board and game monitoring unit (GMU) processing board. These system components may connect over a network to the slot management system (such as a commercially available Bally SDS/SMS) and/or casino management system (such as a commercially available Bally CMP/CMS).

The GMU system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to install on the system components.

The system components include the iView™ processing board and game monitoring unit (GMU) processing board. The GMU and iView™ can be combined into one like the commercially available Bally G™ iView device. This device may have a video mixing technology to mix the EGM processor's video signals with the iView display onto the top box monitor or any monitor on the gaming device.

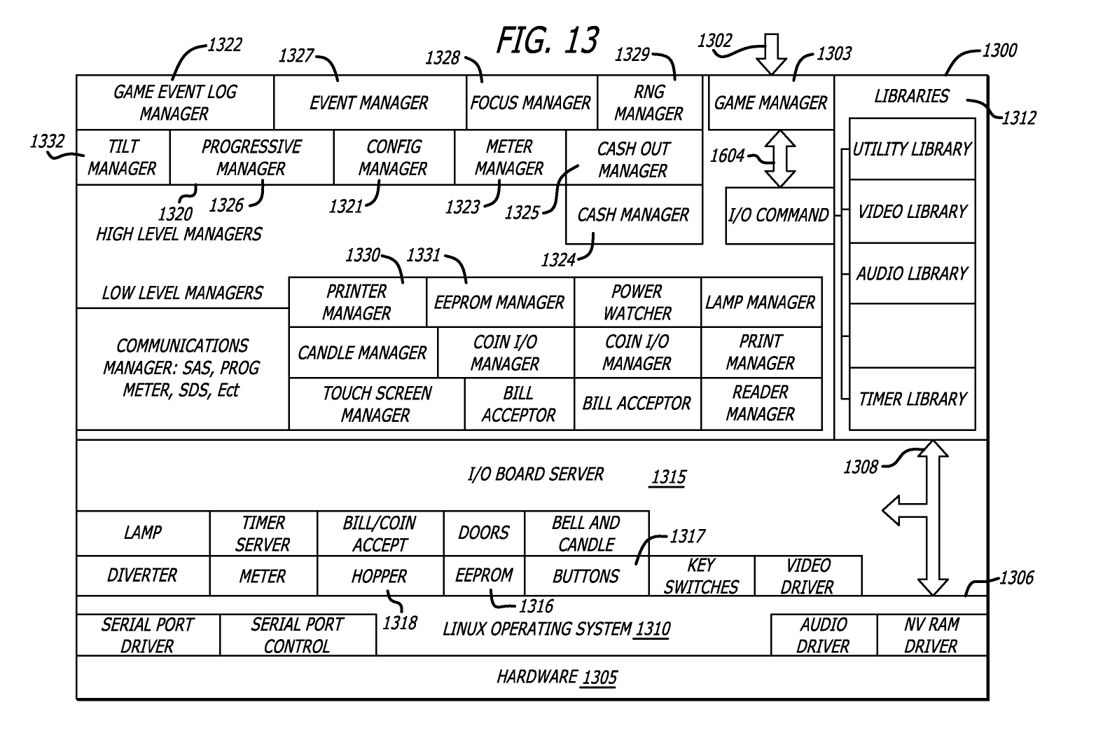

In accordance with one or more embodiments, FIG. 13 is a functional block diagram of a gaming kernel 1300 of a game program under control of base game integrated circuit board 1303. The game program uses gaming kernel 1300 by calling into application programming interface (API) 1302, which is part of game manager 1303. The components of game kernel 1300 as shown in FIG. 13 are only illustrative, and should not be considered limiting. For example, the number of managers may be changed, additional managers may be added or some managers may be removed without deviating from the scope and spirit of the invention.

As shown in the example, there are three layers: a hardware layer 1305; an operating system layer 1310, such as, but not limited to, Linux; and a game kernel layer 1300 having game manager 1303 therein. In one or more embodiments, the use of a standard operating system 1310, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel layer 1300 executes at the user level of the operating system 1310, and itself contains a major component called the I/O Board Server 1315. To properly set the bounds of game application software (making integrity checking easier), all game applications interact with gaming kernel 1300 using a single API 1302 in game manager 1303. This enables game applications to make use of a well-defined, consistent interface, as well as making access points to gaming kernel 1300 controlled, where overall access is controlled using separate processes.

For example, game manager 1303 parses an incoming command stream and, when a command dealing with I/O comes in (arrow 1304), the command is sent to an applicable library routine 1312. Library routine 1312 decides what it needs from a device, and sends commands to I/O Board Server 1315 (see arrow 1308). A few specific drivers remain in operating system 1310's kernel, shown as those below line 1306. These are built-in, primitive, or privileged drivers that are (i) general (ii) kept to a minimum and (iii) are easier to leave than extract. In such cases, the low-level communications is handled within operating system 1310 and the contents passed to library routines 1312.

Thus, in a few cases library routines may interact with drivers inside operating system 1310, which is why arrow 1308 is shown as having three directions (between library utilities 1312 and I/O Board Server 1315, or between library utilities 1312 and certain drivers in operating system 1310). No matter which path is taken, the logic needed to work with each device is coded into modules in the user layer of the diagram. Operating system 1310 is kept as simple, stripped down, and common across as many hardware platforms as possible. The library utilities and user-level drivers change as dictated by the game cabinet or game machine in which it will run. Thus, each game cabinet or game machine may have an base game integrated circuit board 1303 connected to a unique, relatively dumb, and as inexpensive as possible I/O adapter board 1340, plus a gaming kernel 1300 which will have the game-machine-unique library routines and I/O Board Server 1315 components needed to enable game applications to interact with the gaming machine cabinet. Note that these differences are invisible to the game application software with the exception of certain functional differences (i.e., if a gaming cabinet has stereo sound, the game application will be able make use of API 1302 to use the capability over that of a cabinet having traditional monaural sound).

Game manager 1303 provides an interface into game kernel 1300, providing consistent, predictable, and backwards compatible calling methods, syntax, and capabilities by way of game application API 1302. This enables the game developer to be free of dealing directly with the hardware, including the freedom to not have to deal with low-level drivers as well as the freedom to not have to program lower level managers 1330, although lower level managers 1330 may be accessible through game manager 1303's interface 1302 if a programmer has the need. In addition to the freedom derived from not having to deal with the hardware level drivers and the freedom of having consistent, callable, object-oriented interfaces to software managers of those components (drivers), game manager 1303 provides access to a set of upper level managers 1320 also having the advantages of consistent callable, object-oriented interfaces, and further providing the types and kinds of base functionality required in casino-type games. Game manager 1303, providing all the advantages of its consistent and richly functional interface 1302 as supported by the rest of game kernel 1300, thus provides a game developer with a multitude of advantages.

Game manager 1303 may have several objects within itself, including an initialization object (not shown). The initialization object performs the initialization of the entire game machine, including other objects, after game manager 1303 has started its internal objects and servers in appropriate order. In order to carry out this function, the kernel's configuration manager 1321 is among the first objects to be started; configuration manager 1321 has data needed to initialize and correctly configure other objects or servers.

The upper level managers 1320 of game kernel 1300 may include game event log manager 1322 which provides, at the least, a logging or logger base class, enabling other logging objects to be derived from this base object. The logger object is a generic logger; that is, it is not aware of the contents of logged messages and events. The log manager's (1322) job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 1323 manages the various meters embodied in the game kernel 1300. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 1323 receives its initialization data for the meters, during start-up, from configuration manager 1321. While running, the cash in (1324) and cash out (1325) managers call the meter manager's (1323) update functions to update the meters. Meter manager 1323 will, on occasion, create backup copies of the soft meters by storing the soft meters' readings in EEPROM. This is accomplished by calling and using EEPROM manager 1331.

In accordance with still other embodiments, progressive manager 1326 manages progressive games playable from the game machine. Event manager 1327 is generic, like log manager 1322, and is used to manage various gaming machine events. Focus manager 1328 correlates which process has control of various focus items. Tilt manager 1332 is an object that receives a list of errors (if any) from configuration manager 1321 at initialization, and during game play from processes, managers, drivers, etc. that may generate errors. Random number generator manager 1329 is provided to allow easy programming access to a random number generator (RNG), as a RNG is required in virtually all casino-style (gambling) games. RNG manager 1329 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 1325 has the responsibility of configuring and managing monetary output devices. During initialization, cash out manager 1325, using data from configuration manager 1321, sets the cash out devices correctly and selects any selectable cash out denominations. During play, a game application may post a cash out event through the event manager 1327 (the same way all events are handled), and using a call-back posted by cash out manager 1325, cash out manager 1325 is informed of the event. Cash out manager 1325 updates the credit object, updates its state in non-volatile memory, and sends an appropriate control message to the device manager that corresponds to the dispensing device. As the device dispenses dispensable media, there will typically be event messages being sent back and forth between the device and cash out manager 1325 until the dispensing finishes, after which cash out manager 1325, having updated the credit manager and any other game state (such as some associated with meter manager 1323) that needs to be updated for this set of actions, sends a cash out completion event to event manager 1327 and to the game application thereby. Cash in manager 1324 functions similarly to cash out manager 1325, only controlling, interfacing with, and taking care of actions associated with cashing in events, cash in devices, and associated meters and crediting.

In a further example, in accordance with one or more embodiments, I/O server 1315 may write data to the gaming machine EEPROM memory, which is located in the gaming machine cabinet and holds meter storage that must be kept even in the event of power failure. Game manager 1303 calls the I/O library functions to write data to the EEPROM. The I/O server 1315 receives the request and starts a low priority EEPROM thread 1316 within I/O server 1315 to write the data. This thread uses a sequence of 8 bit command and data writes to the EEPROM device to write the appropriate data in the proper location within the device. Any errors detected will be sent as IPC messages to game manager 1303. All of this processing is asynchronous.

In accordance with one embodiment, button module 1317 within I/O server 1315, polls (or is sent) the state of buttons every 2 ms. These inputs are debounced by keeping a history of input samples. Certain sequences of samples are required to detect a button was pressed, in which case the I/O server 1315 sends an inter-process communication event to game manager 1303 that a button was pressed or released. In some embodiments, the gaming machine may have intelligent distributed I/O which debounces the buttons, in which case button module 1317 may be able to communicate with the remote intelligent button processor to get the button events and simply relay them to game manager 1303 via IPC messages. In still another embodiment, the I/O library may be used for pay out requests from the game application. For example, hopper module 1318 must start the hopper motor, constantly monitor the coin sensing lines of the hopper, debounce them, and send an IPC message to the game manager 1303 when each coin is paid.

Further details, including disclosure of lower level fault handling and/or processing, are included in U.S. Pat. No. 7,351,151 entitled “Gaming Board Set and Gaming Kernel for Game Cabinets” and provisional U.S. patent application No. 60/313,743, entitled “Form Fitting Upgrade Board Set For Existing Game Cabinets,” filed Aug. 20, 2001; said patent and provisional are both fully incorporated herein by explicit reference.

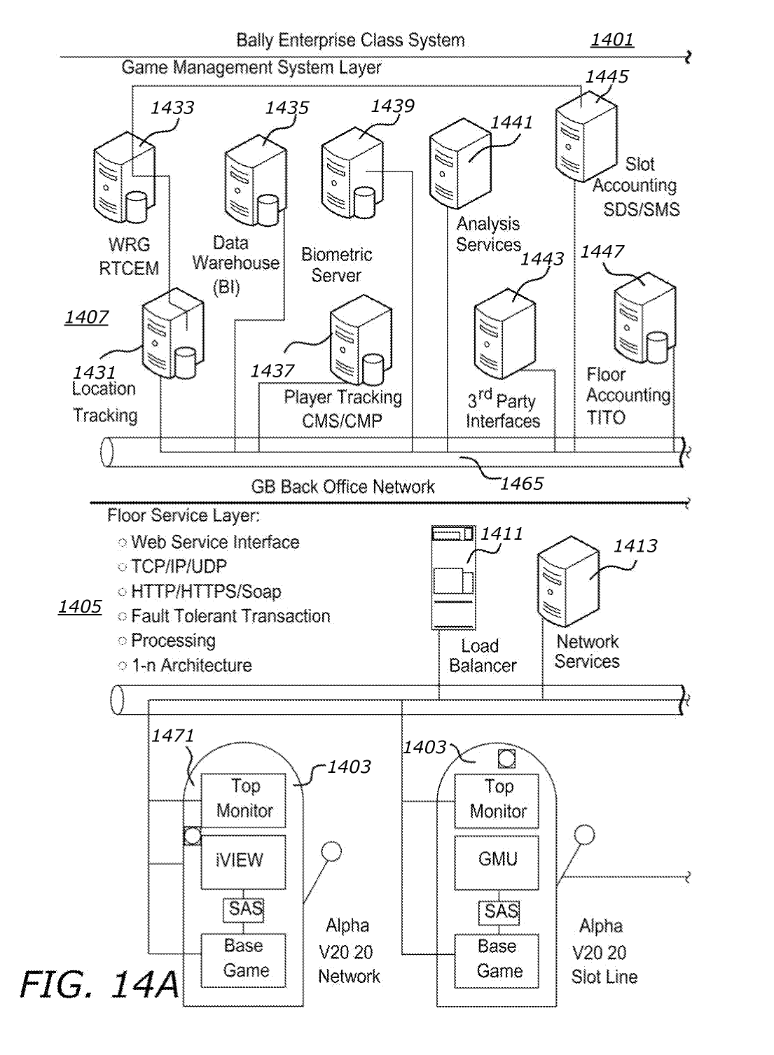

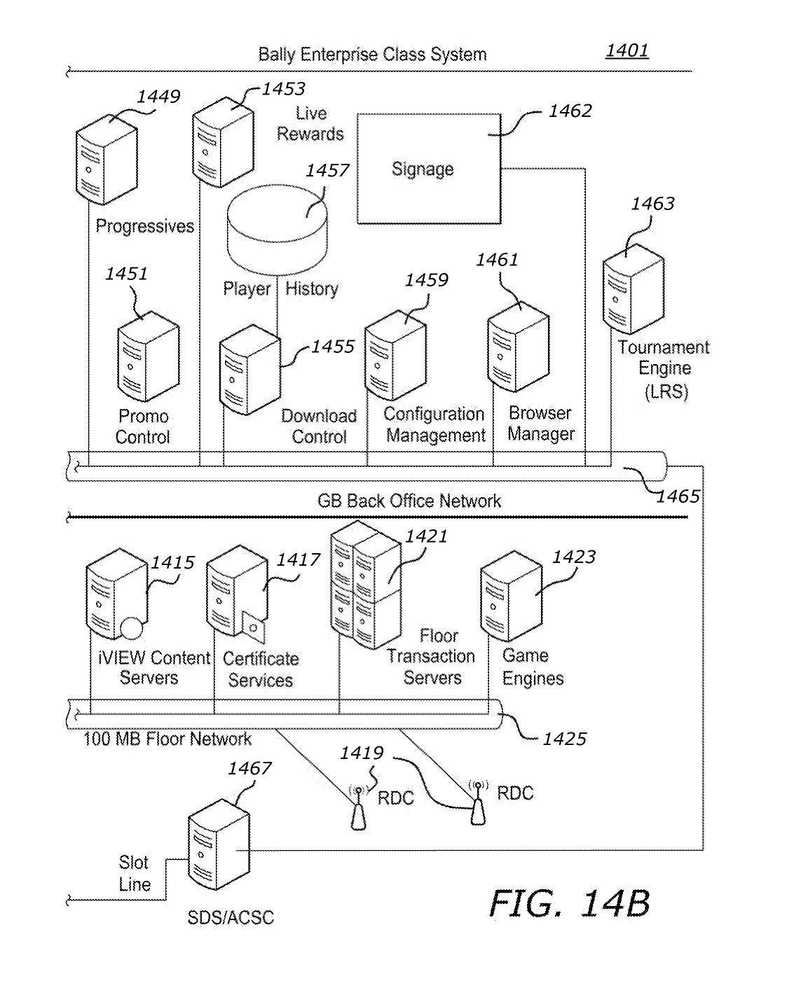

Referring to FIGS. 14A and 14B, enterprise gaming system 1401 is shown in accordance with one or more embodiments. Enterprise gaming system 1401 may include one casino or multiple locations and generally includes a network of gaming machines 1403, floor management system (SMS) 1405, and casino management system (CMS) 1407. SMS 1405 may include load balancer 1411, network services servers 1413, player interface (iView) content servers 1415, certificate services server 1417, floor radio dispatch receiver/transmitters (RDC) 1419, floor transaction servers 1421 and game engines 1423, each of which may connect over network bus 1425 to gaming machines 1403. CMS 1407 may include location tracking server 1431, WRG RTCEM server 1433, data warehouse server 1435, player tracking server 1437, biometric server 1439, analysis services server 1441, third party interface server 1443, slot accounting server 1445, floor accounting server 1447, progressives server 1449, promo control server 1451, feature game (such as Bally Live Rewards) server 1453, download control server 1455, player history database 1457, configuration management server 1459, browser manager 1461, tournament engine server 1463 connecting through bus 1465 to server host 1467 and gaming machines 1403. The various servers and gaming machines 1403 may connect to the network with various conventional network connections (such as, for example, USB, serial, parallel, RS485, Ethernet). Additional servers which may be incorporated with CMS 1407 include a responsible gaming limit server (not shown), advertisement server (not shown), and a control station server (not shown) where an operator or authorized personnel may select options and input new programming to adjust each of the respective servers and gaming machines 1403. SMS 1405 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

Gaming machines 1403 include various peripheral components that may be connected with USB, serial, parallel, RS-485 or Ethernet devices/architectures to the system components within the respective gaming machine. The GMU has a connection to the base game through a serial SAS connection. The system components in the gaming cabinet may be connected to the servers using HTTPs or G2S over Ethernet. Using CMS 1407 and/or SMS 1405 servers and devices, firmware, media, operating systems, and configurations may be downloaded to the system components of respective gaming machines for upgrading or managing floor content and offerings in accordance with operator selections or automatically depending upon CMS 1407 and SMS 1405 master programming. The data and programming updates to gaming machines 1403 are authenticated using conventional techniques prior to install on the system components.

In various embodiments, any of the gaming machines 1403 may be a mechanical reel spinning slot machine or a video slot machine or a gaming machine offering one or more of the above described games including a group play game. Alternately, gaming machines 1403 may provide a game with a simulated musical instrument interface as a primary or base game or as one of a set of multiple primary games selected for play by a random number generator. A gaming system of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. Patent Publication No. 20080139305, entitled “Networked System and Method for Group Play Gaming,” filed on Nov. 9, 2007, which is hereby incorporated by reference in its entirety for all purposes.

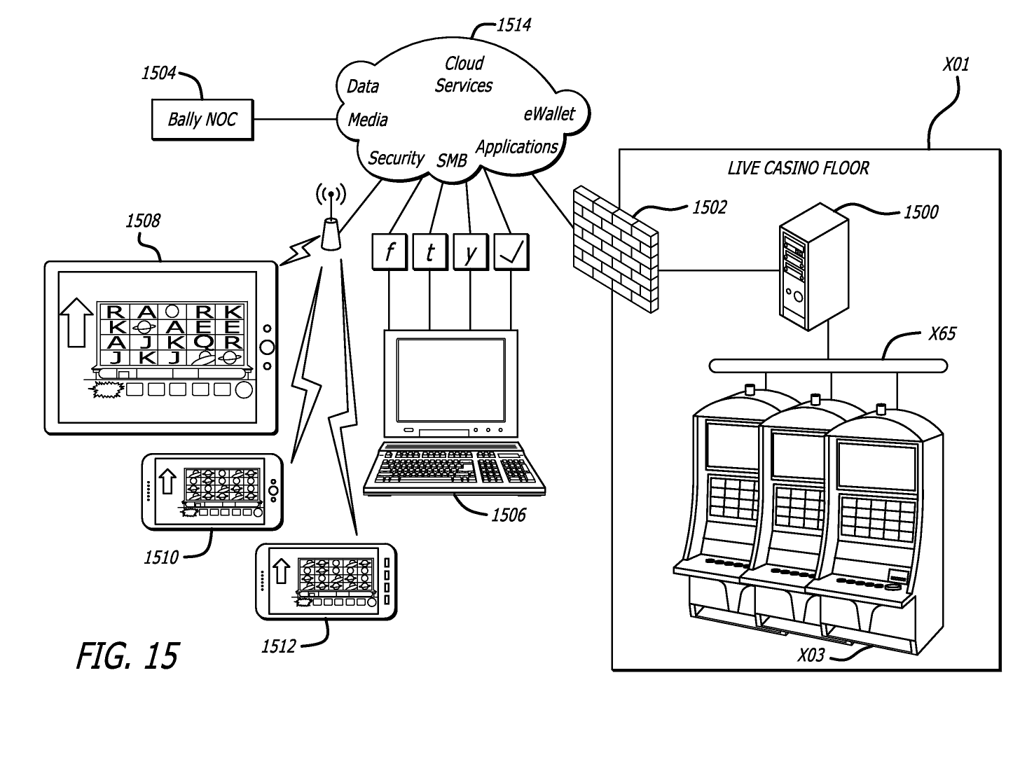

All or portions of the present invention may also be implemented or promoted by or through a system as suggested in FIG. 15. At 1401 is the gaming system of FIGS. 14A and 14B, which may be hosted at a casino property enterprise, across several casino enterprises or by a third party host. As described above, the gaming system 1401 has a network communication bus 1465 providing for communication between the gaming terminals 1403 and various servers. To provide the functionality illustrated in FIG. 15, a bonusing server 1500, such as a Bally Elite Bonusing Server is connected to the network communication bus 1465 (FIGS. 14A and 14B) for communication to the gaming system 1401, the gaming terminals 1403 and the various servers and other devices as described above. Through a secure network firewall 1502 the bonusing server 1500 is in communication with a cloud computing/storage service 1504 which may be hosted by the casino enterprise, a licensed third party or if permitted by gaming regulators an unlicensed provider. For example the cloud service 1504 may be as provided by Microsoft® Private Cloud Solutions offered by Microsoft Corp. of Redmond, Wash., USA. The cloud service 1504 provides various applications which can be accessed and delivered to, for example, personal computers 1506, portable computing devices such as computer tablets 1508, personal digital assistants (PDAs) 1510 and cellular devices 1512 such as telephones and smart phones. As but an example, the cloud service 1504 may store and host an eWallet application, casino or player-centric applications such as downloadable or accessible applications including games, promotional material or applications directed to and/or affecting a casino customers interaction with a casino enterprise (such as accessing the players casino account, establishing casino credit or the like), providing bonuses to players through system wide bonusing (SMB) or specific bonusing or comps to players, or other applications. The cloud service 1504 includes security provide for secure communication with the cloud service 1504 between the player/users and the cloud service 1504 and between the cloud service 1504 and the gaming system 1401. Security applications may be through encryption, the use of personal identification numbers (PINS) or other devices and systems. As suggested in FIG. 15, the cloud service 1514 stores player/user data retrieved from players/users and from the gaming system 1401.

The players/users may access the cloud service 1504 and the applications and data provided thereby through the Internet or through broadband wireless cellular communication systems and any intervening sort range wireless communication such as WiFi. The players/users may access the applications and data through various social media offerings such as Facebook, Twitter, Yelp, MySpace, LinkedIn or the like.

As but an example, a player/user may have a player account with a casino enterprise Z. That account may include data such as the player's credit level, their rating and their available comps. The account may further track any certificates, and the present value thereof, the player may have won as a result of the playing a game according to the present invention. At their smart phone 1512 the player/user sends a request to the clout service 1504 (perhaps through a previously downloaded application) to request the status of their available comps such as how many comp points they have and what may be available through redemption of those points (e.g. lodging, cash back, meals or merchandise). The application for the request may present casino promotions, graphics or other advertising to the player/user. The application, to support such a request, would typically require the player/user to enter a PIN. The cloud service 1004 forwards the inquiry to the bonusing servicer 1500 which, in turn, confirms the PIN and retrieves the requested information from the data warehouse 1435 (FIGS. 14A & 14B) or player tracking CMS/CMP server 1437 (FIGS. 14A & 14B). Alternatively the data may be stored in the cloud service 1504 and routinely updated from the data warehouse 1435 or player tracking CMS/CMP server 1437. In this instance the request would be responded to from data residing with the cloud service 1504. The information is formatted by the cloud server 1504 application and delivered to the player/user. The delivery may be formatted based upon the player/user's device operating system (OS), display size or the like.

The cloud service 1500 may also host game applications to provide virtual instances of games for free, promotional, or where permitted, P2P (Pay to Play) supported gaming. Third party developers may also have access to placing applications with the cloud service 1504 through, for example a national operations center (Bally NOC 1514). A game software manufacturer such as Bally Gaming, Inc. may also provide game applications on its own or on behalf of the casino enterprise.

Other media such as advertising, notices (such as an upcoming tournament) may also be provided to the cloud service 1504. When a player/user accesses the cloud service 1504 certain media may be delivered to the player/user in a manner formatted for their application and device.

The details of an embodiment of the invention are disclosed in the Appendix. While the embodiment described relates to a Baccarat game it should be understood that the inventive concept could be applied to other games particularly those where inter-play player decisions are not required. For example, a slot machine, either electro-mechanical or video may operate one or more virtual games in the background and routinely report an outcome history to the player playing the primary, displayed, version of the game. The player may then compare the histories to the primary game and choose to instead play one of the one or more virtual background versions of the game. Each game version may operate from a differently seeded random number generator so the results (and histories may differ).

Still further the histories displays may be displayed at a window to either side, above or below the primary game version being wagered upon and played by the player or in a scrolling, ticker display again above or below or to either side of the primary game display. In such a fashion the player may view the histories and select a version of the game which the player may feel is “hotter” and is having better outcomes.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

While various embodiments have been described above, it should be understood that they have been presented by way of example only, and not limitation. Thus, the breadth and scope of a disclosed embodiment should not be limited by any of the above-described exemplary embodiments, but should be defined only in accordance with the following claims and their equivalents.

What is claimed:

1. A video gaming machine, the system comprising:
one or more game processors;
one or more video displays;
a player input device configured to enable a player to control play of the game;
a memory device storing software to control the game processor and configured to:
enable the player to select a virtual Baccarat game to play from a plurality of virtual Baccarat games on a virtual game floor;
display play by the player of the selected Baccarat game on the one or more video displays;
display virtual gameplay of the non-selected Baccarat games from the plurality of virtual Baccarat games on a virtual game floor;
display on the one or more video displays an outcome history of the play of the selected Baccarat games; and
enable the player to choose to begin playing a non-selected Baccarat game instead of the selected Baccarat game from the plurality of virtual Baccarat games on a virtual game floor, wherein the choice to exchange a non-selected Baccarat game with the selected Baccarat game for further game play is made by the player.

2. The system of claim 1, wherein the software is further configured to: enable the player to make a wager on the selected Baccarat game.

3. The system of claim 1, wherein the selected Baccarat game includes an associated virtual card shoe and an associated outcome history.

4. The system of claim 3, wherein the virtual card shoe contains virtual cards of a virtual deck, and wherein once a virtual card is played from the virtual deck, the played virtual card cannot be played again until after a virtual shuffle of the virtual deck.

5. The system of claim 1, wherein at least one non-selected Baccarat game includes an associated virtual card shoe and an associated outcome history.

6. The system of claim 1, wherein each of the non-selected Baccarat games includes an associated virtual card shoe and an associated outcome history.

7. The system of claim 6, wherein each of the non-selected Baccarat games and the associated virtual card shoes and associated outcome histories are viewable by the player when playing the selected Baccarat game.

8. The system of claim 7, wherein selection by the player of an initially non-selected Baccarat game to play transfers the associated virtual card shoe and associated outcome history with the initially non-selected Baccarat game.

9. The system of claim 7, wherein selection by the player of an initially non-selected Baccarat game to play transfers the virtual card shoe and outcome history associated with an initially selected Baccarat game to a background table in the plurality of virtual Baccarat games on a virtual game floor.

10. The system of claim 1, wherein outcome histories from a plurality of the non-selected Baccarat games are concurrently viewable by the player when playing the selected Baccarat game on the video gaming machine.

11. A video gaming system, the system comprising:
one or more game processors;
one or more video displays;
a player input device configured to enable a player to control play of the game;
a memory device storing software to control the game processor and configured to:
enable the player to select one of a first Baccarat game or a second Baccarat game to play on a virtual game floor;
display play by the player of the selected Baccarat game at the one or more video displays;
display virtual play of the non-selected Baccarat game on the virtual game floor;
display on the one or more video displays an outcome history of the play of the selected Baccarat game; and
enable the player to choose to begin playing the non-selected Baccarat game instead of the selected Baccarat game, wherein the choice to exchange the non-selected Baccarat game with the selected Baccarat game for further game play is made by the player.

12. The system of claim 11, wherein the software is further configured to: enable the player to make a wager on the selected Baccarat game.

13. The system of claim 11, wherein the selected Baccarat game includes an associated virtual card shoe and an associated outcome history.

14. The system of claim 13, wherein the virtual card shoe contains virtual cards of a virtual deck, and wherein once a virtual card is played from the virtual deck, the played virtual card cannot be played again until after a virtual shuffle of the virtual deck.

15. The system of claim 11, wherein the non-selected Baccarat game includes an associated virtual card shoe and an associated outcome history.

16. The system of claim 15, wherein the non-selected Baccarat games and the associated virtual card shoe and associated outcome history are viewable by the player when playing the selected Baccarat game.

17. The system of claim 16, wherein selection by the player of an initially non-selected Baccarat game to play transfers the associated virtual card shoe and associated outcome history with the initially non-selected Baccarat game for current play by the player.

18. The system of claim 16, wherein selection by the player of an initially non-selected Baccarat game to play transfers the virtual card shoe and outcome history associated with an initially selected Baccarat game to a background table on the virtual game floor.

19. The system of claim 11, wherein outcome histories from a plurality of the non-selected Baccarat games are concurrently viewable by the player when playing the selected Baccarat game on the video gaming machine.

20. A method of playing a video gaming system including one or more game processors, one or more video displays, a player input device configured to enable a player to control play of the game, and a memory device that stores software and controls the game processor, the method comprising:
enabling the player to select one of a first Baccarat game or a second Baccarat game to play on a virtual game floor;
displaying play by the player of the selected Baccarat game at the one or more video displays;
displaying virtual play of the non-selected Baccarat game on the virtual game floor;
displaying on the one or more video displays an outcome history of the play of the selected Baccarat games; and
enabling the player to choose to begin playing the non-selected Baccarat game instead of the selected Baccarat game, wherein the choice to exchange the non-selected Baccarat game with the selected Baccarat game for further game play is made by the player.

21. The method of claim 20, further comprising: enabling the player to make a wager on the selected Baccarat game.

22. The method of claim 20, wherein the selected Baccarat game includes an associated virtual card shoe and an associated outcome history.

23. The method of claim 22, wherein the virtual card shoe contains virtual cards of a virtual deck, and wherein once a virtual card is played from the virtual deck, the played virtual card cannot be played again until after a virtual shuffle of the virtual deck.

24. The method of claim 20, wherein the non-selected Baccarat game includes an associated virtual card shoe and an associated outcome history.

25. The method of claim 24, wherein the non-selected Baccarat games and the associated virtual card shoe and associated outcome history are viewable by the player when playing the selected Baccarat game.

26. The method of claim 25, wherein selection by the player of an initially non-selected Baccarat game to play transfers the associated virtual card shoe and associated outcome history with the initially non-selected Baccarat game for current play by the player.

27. The method of claim 25, wherein selection by the player of an initially non-selected Baccarat game to play transfers the virtual card shoe and outcome history associated with an initially selected Baccarat game to a background table on the virtual game floor.

28. The system of claim 20, wherein outcome histories from a plurality of the non-selected Baccarat games are concurrently viewable by the player when playing the selected Baccarat game on the video gaming machine.

29. A video gaming machine, the system comprising:
one or more game processors;
one or more video displays;
a player input device configured to enable a player to control play of the game;
a memory device storing software to control the game processor and configured to:
enable the player to select a virtual game to play from a plurality of virtual games on a virtual game floor;
display play by the player of the selected game on the one or more video displays;
display virtual gameplay of the non-selected games from the plurality of virtual games on a virtual game floor;
display on the one or more video displays an outcome history of the play of the selected games; and
enable the player to choose to begin playing a non-selected game instead of the selected game from the plurality of virtual games on a virtual game floor, wherein the choice to exchange a non-selected game with the selected game for further game play is made by the player.
